(19) United States
(12) Patent Application Publication
(10) Pub. No.: US 2025/0163233 A1
(43) Pub. Date: May 22, 2025

(54) EXPANDABLE POLYLACTIC ACID FOAM ARTICLES WITH RIDGES AND ASSOCIATED METHODS

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/955,214

(22) Filed: Nov. 21, 2024

Related U.S. Application Data
(60) Provisional application No. 63/601,596, filed on Nov. 21, 2023.

(51) Int. Cl. C08J 9/232; C08J 9/00; C08K 3/04

(52) U.S. Cl. CPC C08J 9/232; C08J 9/0066; C08K 3/04; C08J 2203/22; C08J 2367/04

(57) ABSTRACT

Molded foam articles having ridges are provided. The ridges in the molded foam articles advantageously enable tunable compression and impact properties while reducing overall material usage through the modification of ridge shape and size.

### CROSS-REFERENCE TO RELATED APPLICATION

This application claims priority to U.S. Provisional Application No. 63/601,596, filed Nov. 21, 2023, which is incorporated herein by reference.

### FIELD OF THE DISCLOSURE

This disclosure relates generally to molded bead-foam articles and, in particular, relates to the molded bead-foam articles having ridged structures for improved compressive properties.

### BACKGROUND

Product packaging serves as vibration protection, impact protection, and external packaging for product identification. These functions must be preserved while reducing the weight, size, carbon footprint, and material usage associated with consumer, medical, and industrial goods.

Expandable polystyrene (EPS) is commonly used for product packaging because of its well-known manufacturing process and predictable impact and vibration protection. However, EPS is known to be a “single-drop” material. In other words, EPS experiences permanent and continued deformation or dimension reduction after one impact-causing drop and after each subsequent drop. As the EPS compresses, either from drops of from any sort of compression action, the impact properties of the EPS continuously worsen.

Another material commonly used for product packaging is convoluted polyurethane foam, characterized by the formation of columnar shapes. “Egg carton” polyurethane foam, for example, utilizes rounded protrusions to artificially increase the thickness of the foam without substantially increasing the weight, thereby achieving improved impact protection over flat, non-convoluted foam. While polyurethane foam readily recovers from compression cycles, polyurethane foam is very flexible has a very low compression modulus compared to EPS-based foam.

A material which does not permanently deform when repeatedly compressed is therefore desired to provide improved impact protection to shipped goods.

### BRIEF DESCRIPTION OF THE DRAWINGS

The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 depicts a package with molded foam articles having ridges in accordance with the present disclosure.

FIG. 2 depicts an EPLA-based molded foam article in accordance with the present disclosure.

FIG. 3 depicts an EPS-based molded foam article.

FIGS. 4A-4B depict an EPS-based molded foam article having ridges.

FIGS. 5A-5B depict an EPLA-based molded foam article having ridges in accordance with the present disclosure.

FIG. 6 is a chart of Force versus Displacement for an EPLA-based molded foam article having ridges in accordance with the present disclosure.

FIG. 7 is a chart of Force versus Displacement for an EPS-based molded foam article having ridges.

FIG. 8 is a chart of Force versus Displacement for an EPLA-based molded foam article having ridges and an EPS-based molded foam article.

FIG. 9 is a chart of Force versus Cross-Sectional Area for molded foam articles.

FIG. 10 is a chart of Force versus Cross-Sectional Area for molded foam articles.

FIG. 11 is a chart of Compressive Modulus versus Cross-Sectional Area for molded foam articles.

FIG. 12 is a chart of Compressive Modulus versus Cross-Sectional Area for molded foam articles.

FIG. 13 is a chart of height versus Compression Cycles for molded foam articles.

FIG. 14 is a ridge in accordance with the present disclosure.

FIG. 15 is a ridge in accordance with the present disclosure.

FIG. 16 is a ridge in accordance with the present disclosure.

FIG. 17 is a ridge in accordance with the present disclosure.

### DETAILED DESCRIPTION

Molded foam articles and methods of making molded foam articles are provided herein including molded foam articles formed from polylactic acid having at least one ridge. In particular, it has been unexpectedly discovered that forming the molded foam article from polylactic acid and incorporating at least one ridge, as described in further detail herein, results in the formation of a foam article with unique mechanical properties compared to a non-ridged article. The ridged article exhibits advantageous strength, compressive modulus, and impact protection. Furthermore, the incorporation of ridges enables packaging solutions with lower weight, lower material usage, and improved ability to load foam in secondary packaging such as a corrugated box.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the terms “about” and “approximately” with reference to dimensions refers to the dimension plus or minus 10%.

### Molded Foam Articles

Molded foam articles are disclosed herein. In some embodiments, the molded foam articles are formed from expandable polylactic acid (EPLA). In some embodiments, producing the molded bead-foam article may be performed according to the methods described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC, each of which are incorporated herein by reference in their entirety. By forming the molded bead-foam articles from EPLA, the molded bead-foam articles are biodegradable and compostable.

In some embodiments, the molded foam article includes at least one ridge. As used herein, a “ridge” refers to a convolution in the surface of the molded foam article. The ridge may take the form of a single elevation change so that the molded foam article has a lower surface and an upper surface. The ridge may take the form of two elevation changes so that either an elevated protrusion exists on the surface of the molded foam article or a recessed channel exists in the surface of the molded foam article. The protrusion or channel may be continuous and run the length of the surface of the molded foam article, or there may be one or more discrete protrusions/channels such as bumps, columns, mounds, cavities, or the like. These bumps or cavities may take the form of, for example, triangular pyramids, triangular prisms, rectangular prisms, honeycomb-shaped bumps/cavities, or another suitable shape. There may be two ridges, such as two discrete protrusions running the length of the molded foam article or two discrete channels running the length of the molded foam article. There may be one protrusion and one channel, or some other combination of protrusions and channels. The ability to form the molded foam article with protrusion(s) and channel(s) of any shape and number enables highly customizable tuning of mechanical properties.

The ridges described herein may therefore have a variety of shapes, thicknesses, lengths, etc. Generally, any shape comprising around 10 beads or fewer is considered a “ridge” as described herein. In some embodiments, the ridge has between about 5 to about 7 beads. By employing specific shapes—such as trapezoidal and triangular ridges, with or without cut-outs—it is possible to lessen the compressive resistance to meet the needs of cushion-like applications while simultaneously reducing material usage. This approach illustrates how shape engineering provides an efficient, sustainable alternative to traditional chemical or density adjustments, enabling customizable performance across a range of applications where compressive resistance and material economy are critical.

It was unexpected that the removal of material would result in improved mechanical properties. Conventional EPS-based molded foam articles experience a reduction in mechanical properties, including impact protection and compressive modulus, when material is removed. As a result, EPS-based molded foam articles are most effective when matching the shape of the packaged product. In contrast, EPLA-based molded foam articles having ridges perform as well or better than EPS-based molded foam articles while consuming less material and, in some cases, having a standardized shape that does not need to perfectly match the packaged product.

In some embodiments, the at least one ridge is formed as part of the same molding process that forms the molded foam article. In other words, the molded foam article and the ridge are monolithic. In some embodiments, the at least one ridge is formed as part of a post-molding subtractive machining process, such as cutting away material with a wire-cutter or mill. In some embodiments, the at least one ridge is formed separately and adhered to a surface of the molded foam article, such as through the adhesion process described in U.S. Patent Pub. No. 20240199301 to Lifoam Industries, LLC which is hereby incorporated by reference. In some embodiments, one or more protrusions and/or one or more channels/cavities are formed in the molded foam article during the initial molding process, and one or more protrusions are subsequently adhered to the surface of the molded foam article.

In some embodiments, the molded foam article has a density that has been increased from an initial post-molding density through at least one compression cycle. It has been unexpectedly discovered that subjecting the molded foam article to at least one compression cycle advantageously improves the resiliency of the molded foam article and enables the molded foam article to fully recover from repeated strains of from about 10% to about 20%. If an EPS-based molded foam article were subjected to a comparable compression cycle, it would significantly reduce the EPS's ability to provide impact protection because of the “single drop” nature of EPS. It was therefore unexpected that a compression cycle before packaging would improve the properties of the EPLA-based molded foam article.

In some embodiments, the molded foam article includes one or more inorganic additives. In some embodiments, the inorganic additive comprises graphite like those described in U.S. Patent Pub. No. 20230383085 to Lifoam Industries, LLC which is hereby incorporated by reference.

In another aspect, a package for shipping a product is disclosed herein, the package comprising a molded foam article as described herein.

### Methods of forming Molded Foam Articles

Methods of forming molded foam articles are also described herein. In one aspect, the methods include forming any of the molded foam articles described above. In another aspect, the methods include molding a plurality of foam beads formed from polylactic acid. In some embodiments, the molding process includes injecting the plurality of foam beads into a mold and subjecting the mold to an elevated temperature and/or reduced pressure to expand the foam beads. In some embodiments, the molding process may be performed according to the methods described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC. In some embodiments, the molded bead-foam article produced by this method is characterized by having at least one ridge.

In some embodiments, the method includes subjecting the molded foam article to at least one compression cycle. In some embodiments, the at least one ridge is formed as part of the molding process. In other embodiments, the method includes forming the at least one ridge and adhering the at least one ridge to the molded foam article.

### EXAMPLES

### Example 1: Comparison of Compression Set Between EPS and EPLA

Closed cell foams such as EPS and EPLA experience a phenomenon called compression set when subjected to repeated compression cycles. The level of compression set is determined by compressing a foam piece by a defined strain and at a defined strain rate and then measuring the foam's recovery once the force is released following each compression cycle.

Molded foam articles were formed from three materials: EPS having a density of 1.3 pounds per cubic foot (PCF), EPLA having a density of 1.6 PCF, and EPLA with graphite additive having a density of 1.5 PCF. Prior to each compression cycle, the molded pieces were visually inspected for cracks. The degree of cracking was quantified over dozens of parts.

A compressive strain of 15% and 25% were investigated with both EPS and EPLA foam blocks with 0.5″ deep ridges with width of 0.75″. The overall dimensions of the foam blocks were 2.5″ on each side. The average compression set value, i.e., the part of the foam which does not recover, for 1^{st} cycle and after 10^{th} cycle are recorded in Table 1.

TABLE 1
Compression Set Measurements

| | | | Average |
|---|---|---|---|
| | Compression | Compression | Number of |
| Material | Set 1^{st} cycle | set 10^{th} cycle | cracks per block |
| EPS (1.3 PCF) | 0.30″ | 0.40″ | 100 |
| EPLA (1.60 PCF) | 0.22″ | 0.30″ | 18.75 |
| EPLA with | 0.16″ | 0.23″ | 0 |
| graphite (1.5 PCF) | | | |

As shown in Table 1, EPLA exhibits greater recovery and a lower level of compression set compared to EPS, and the incorporation of graphite into the EPLA further improves the recovery and compression set. In fact, after only 10 compression cycles, the EPS foam block exhibited upwards of one hundred cracks; using such an EPS foam block for impact protection would provide very little confidence in being able to adequately protect the product. In contrast, the EPLA foam block with graphite exhibited zero cracks.

### Example 2: Protecting Slow Cooker with EPLA Molded Foam with Ridges

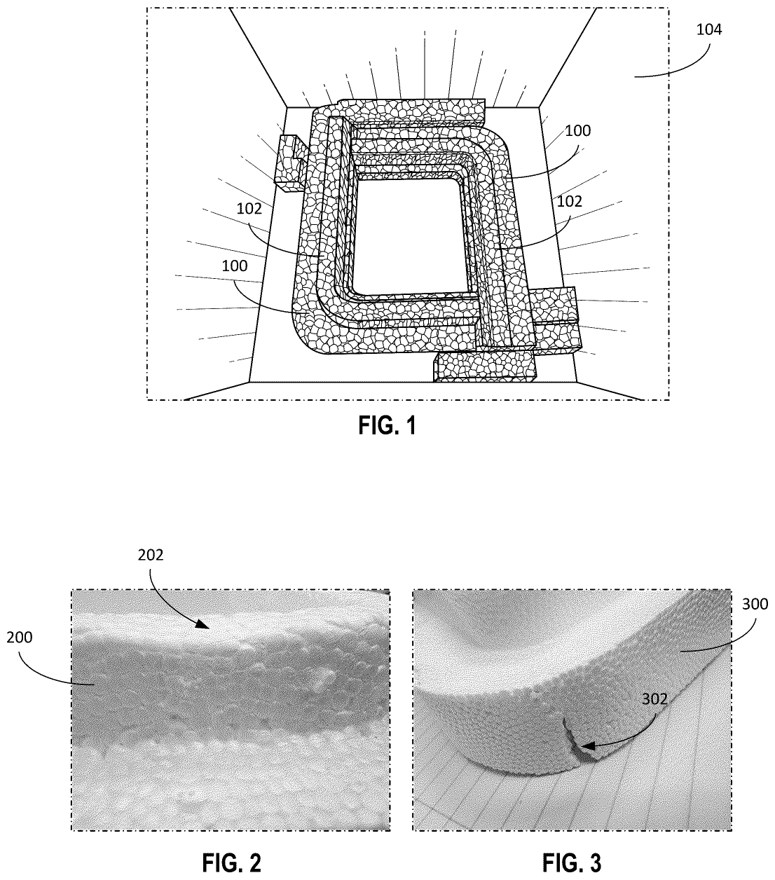

A slow cooker that was originally packed in molded pulp was repackaged with EPLA and EPS foam with ridges. The packed article was dropped multiple times from 18″ height with an accelerometer fastened inside of the slow cooker to measure g-force felt by the appliance. A lower value for the G-force is desirable because lower G-forces indicates a lower potential of breakage. A sample of the packaging is displayed in FIG. 1, which depicts molded foam articles 100 with ridges 102 disposed inside a corrugated cardboard box 104.

The molded foam articles used had ½″ ridge height and width, an overall height of 1.5″, and 1″ thick base. The EPLA and EPS articles had identical dimensions and varied only in the material itself. The G-forces for the five drops are shown in Table 2.

TABLE 2
G-Forces for Dropped Packaging

| | G-Forces (G) | | | | |
|---|---|---|---|---|---|
| Material | Drop 1 | Drop 2 | Drop 3 | Drop 4 | Drop 5 |
| EPS | 2.8 | 8 | 12.2 | 3 | 5.6 |
| EPLA | 1.9 | 1.2 | 2.6 | 1.5 | 2.7 |

As shown in Table 2, with EPLA, the average G-forces of the first two drops with EPLA-based packaging was 1.6G and the last three drops was 2.3G while EPS-based packaging had G forces of 5.4G and 6.9G respectively.

At the location where the three feet of the appliance sat on the foam ridge, the ridge portion of EPLA compressed ⅛″ while the base portion did not compress. The EPS ridge compressed 1/16″ while the base compressed 3/16″. Total height loss where feet sat for EPLA was ⅛″ compared to ¼″ for EPS.

FIG. 2 depicts the EPLA packaging 200 after the five drops performed in this example, while FIG. 3 depicts the EPS packaging after the five drops performed in this example. FIG. 2 depicts slight deformation 202 in the EPLA packaging 200. Meanwhile, FIG. 3 depicts the EPS packaging 300 with a crack 302 propagating upwards. This is expected because EPS is known to be a single drop material. In every case, the crack is observed as starting from the base and propagating upwards through the molded foam article. EPLA had a single crack that was ¾″ while EPS had cracks that were 1 ½″ in two places and three cracks that were ½″ in length. It is anticipated that the incorporation of graphite into the EPLA packaging would eliminate all cracks.

### Example 3: Deformation Comparison Between EPS and EPLA with Graphite

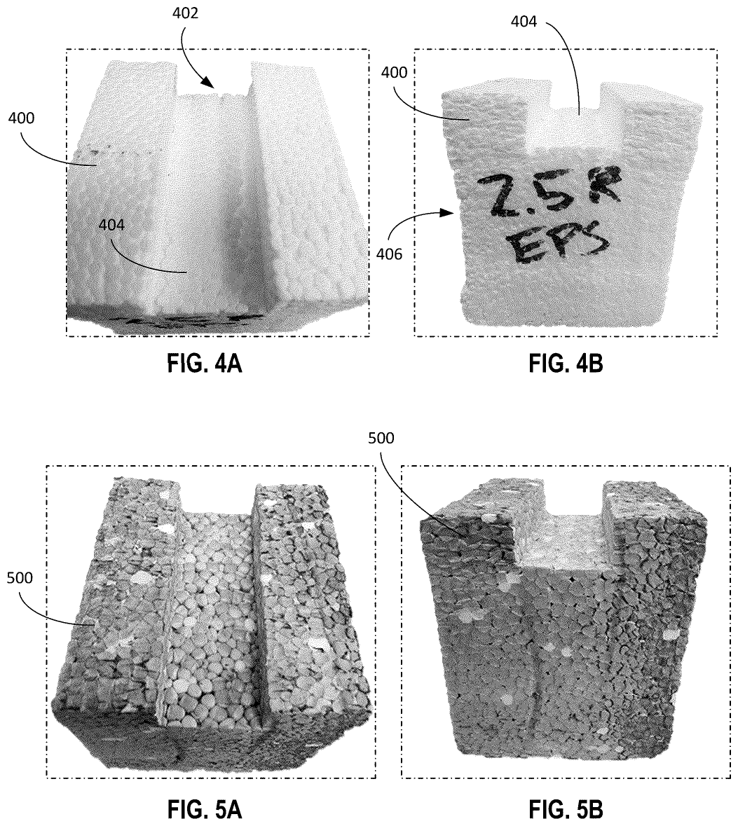

EPLA with graphite and EPS were molded into a shape with a 2.5″ total height and ½″ width and ½″ height of ridge. These samples underwent compression testing of 25% with a strain rate of ½″ per minute with 5-minute delay between each of the 10 cycles. FIGS. 4A-4B depict the EPS sample 400 while FIGS. 5A-5B depict the EPLA sample 500.

In FIGS. 4A-4B, the EPS sample 400 exhibits a crack 402 at the base of the ridge 404. The EPS sample 400 also deformed significantly with the sides 406 bowing inwards. In FIGS. 5A-5B, the EPLA sample 500 had no cracking and no bowing.

In this Example, the EPS sample had a height loss of 1/24″ in the ridge and 8/25″ loss in the base. The ridge shape was mostly intact while the base deformed. In contrast, the ridge in the EPLA sample experienced 1/12″ height loss while the base exhibited 4/25″ height loss. It is believed that the cause of cracks in the EPS sample is the concentration of force in the ridge, resulting in splitting the foam, whereas EPLA experiences more uniform compression in the full molded foam piece.

### Example 4: Compression Curves of EPLA and EPS Foam Articles

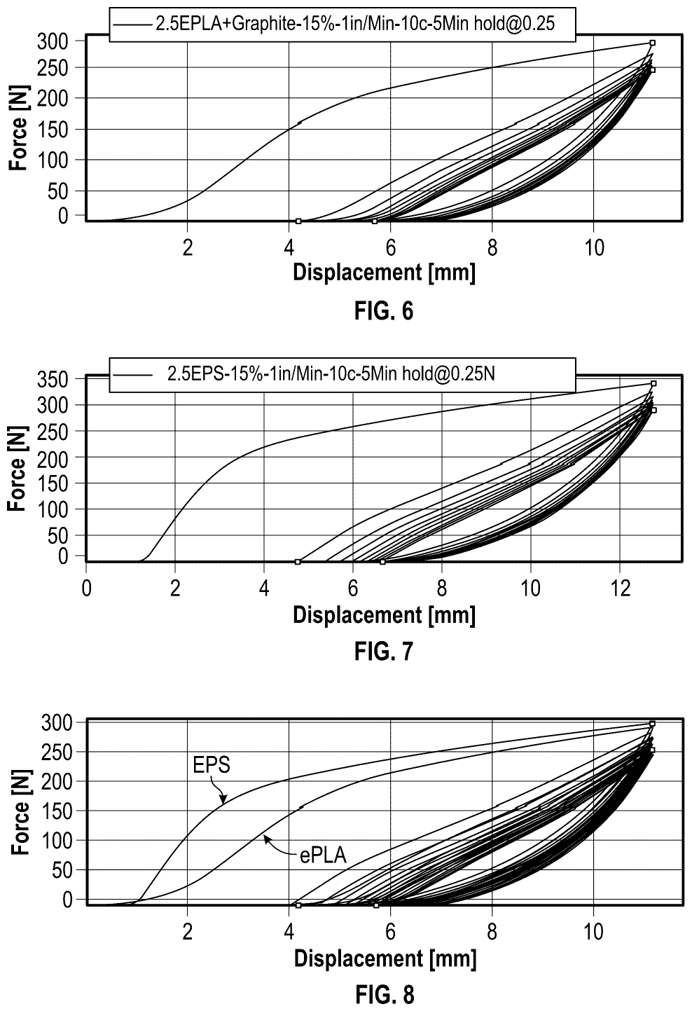

Compression curves of EPLA and EPS were generated using an Instron compression machine, available commercially from Instron Corporation, Norwood, Massachusetts, USA. A 15% strain with a strain rate of 1 in/min were used along with 5-minute delay between each cycle. Data for 10 cycles for EPLA is shown in FIG. 6 and data for 10 cycles for EPS are shown in FIG. 7. FIG. 8 shows the first cycle of EPLA and EPS to allow direct comparison of the shape of the curve.

As depicted in FIGS. 6-8, EPLA requires lower force to compress 15% of the material as compared to EPS. This is more desirable because it means that a product packaged using the EPLA packaging will experience a lower G-force if dropped due to the compression of the EPLA.

### Example 5: Comparison of Compressed Cross-Sectional Area

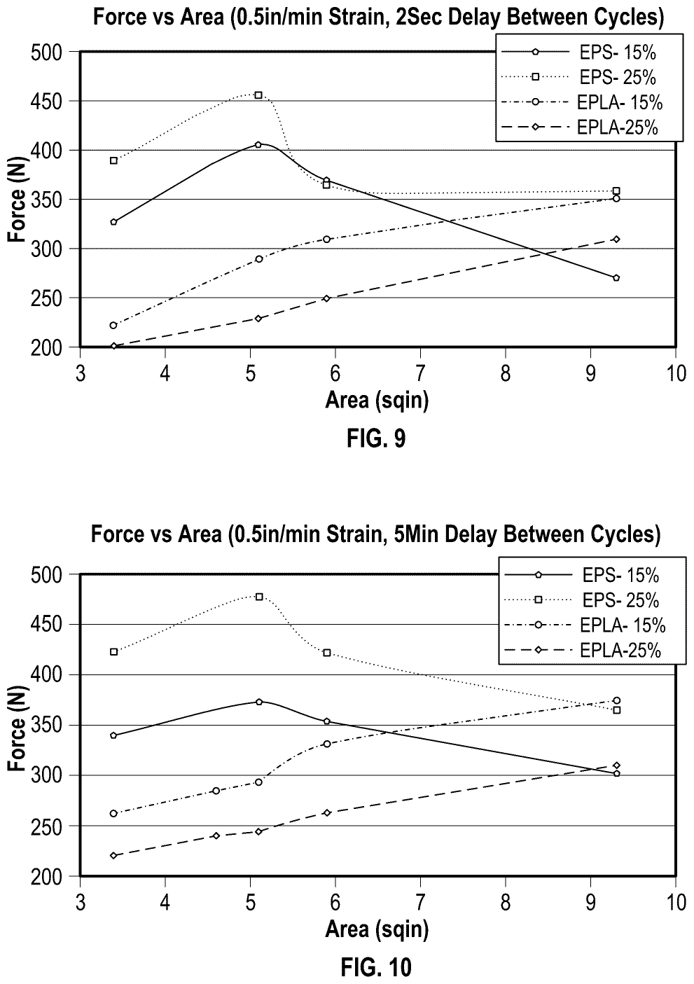

Multiple foam blocks with different thickness ridges were prepared with EPLA containing graphite and EPS. The compressive force for 15% and 25% strain were determined on Instron compression machine. The cross-sectional area of the ridge was calculated from the shape and size of the ridge. FIGS. 9 and 10 show the compressive force for the final compression cycle as a function of the cross-sectional area for both 2-second (FIG. 9) and 5-minute (FIG. 10) delay between cycles. The EPLA sample exhibits an increase in force with an increase in ridge cross-sectional area while EPS exhibits a complicated behavior depending on the number of beads. The EPS sample exhibits higher force with ridges made with fewer number of beads vs. ridges with more beads.

The graphs and the crack results shown previously demonstrate that EPS is an unsuitable material for making thin features such as ridges. EPLA containing graphite and EPLA by itself are capable of forming functional thin features.

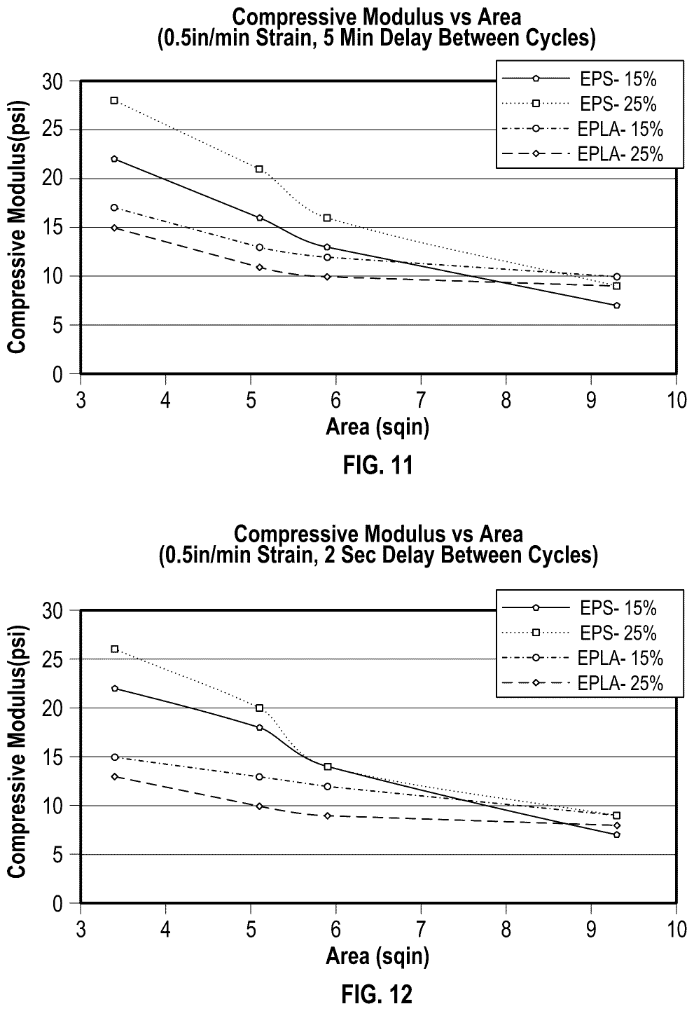

The data from FIGS. 9 and 10 were scaled with area to determine the compressive modulus and was plotted as a function of ridge area. The results are depicted in FIG. 11 (2-second delay) and FIG. 12 (5-minute delay). Only the response for the 10^{th} cycle is shown. These data demonstrate the ability to achieve lower compressive modulus foam support with less material.

### Example 6: Comparison of Compression Versus Force

Molded foam articles were formed as described herein out of EPS and EPLA and were wire cut into 1.5″×1.5″×1.5″ cubes. These blocks were subjected to compression at a strain rate of 0.5″/min down to 25% compression or 0.375″. This was repeated three times taking note of the force experienced and the recovery height between each cycle. Table 3 depicts the force experienced by these samples.

TABLE 3
Force Experienced by EPS and EPLA Samples

Force Experienced (N)

| | 1st | 2nd | 3rd | 4th | 5th | 6th |
|---|---|---|---|---|---|---|
| | com- | com- | com- | com- | com- | com- |
| | press | press | press | press | press | press |
| EPS | 210 | 201 | 195 | 214 | 206 | 193 |
| EPLA #1 | 151 | 142 | 140 | 153 | 146 | 143 |
| EPLA #2 | 181 | 167 | 153 | 184 | 171 | 170 |
| EPLA #3 | 161 | 147 | 142 | 155 | 145 | 144 |

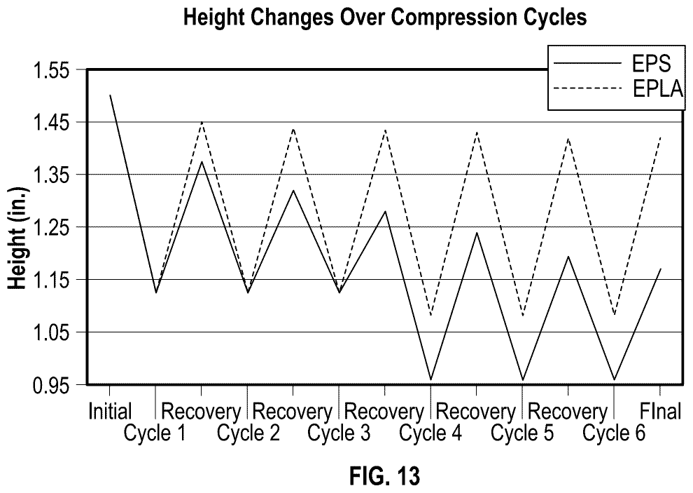

After three cycles, the samples were measured and heights between 1.28″ to 1.45″ were noted. For the second set of compression cycles it was desired to test again at 25% deflection. For each material it was determined what deflection distance was required to reach 25% deflection before being compressed to reach the calculated deflection distance. This compression was performed three times (cycles 4-6). During each of these cycles, the recovery height was noted as well as the force experienced. For example, after the first three sets of compression cycles, EPS samples had a height of 1.28″ so 25% deflection would equal 0.34″ deflection distance, while ePLA had a height of 1.44″ so the required deflection distance was 0.36″. The results are displayed in Table 4 and depicted in FIG. 13.

TABLE 4
Height after Compression Cycles

| | | Height | Height | Height | Height | Height | Height |
|---|---|---|---|---|---|---|---|
| | Initial | after 1 | after 2 | after 3 | after 4 | after 5 | after 6 |
| | Height | Cycle | Cycles | Cycles | Cycles | Cycles | Cycles |
| | (in.) | (in.) | (in.) | (in.) | (in.) | (in.) | (in.) |
| EPS | 1.5 | 1.375 | 1.32 | 1.28 | 1.24 | 1.195 | 1.17 |
| EPLA #1 | 1.5 | 1.44 | 1.3875 | 1.375 | 1.375 | 1.35 | 1.32 |
| EPLA #2 | 1.5 | 1.45 | 1.44 | 1.4375 | 1.43 | 1.42 | 1.42 |
| EPLA #3 | 1.5 | 1.48 | 1.47 | 1.45 | 1.45 | 1.44 | 1.43 |

As best illustrated in FIG. 13, each recovery phase for the EPS-based samples continuously reduced in height until the height of the EPS sample was only about 1.2″ from an initial height of 1.5″. In contrast, the EPLA based sample had a height after these cycles of about 1.42″ from an initial height of 1.5″. The ability to produce and sell a pre-compressed foam product which has higher recovery upon repeated cycles in highly desirable in packaging and commercial applications.

### Example 7: Trapezoidal Ridge Shape Test

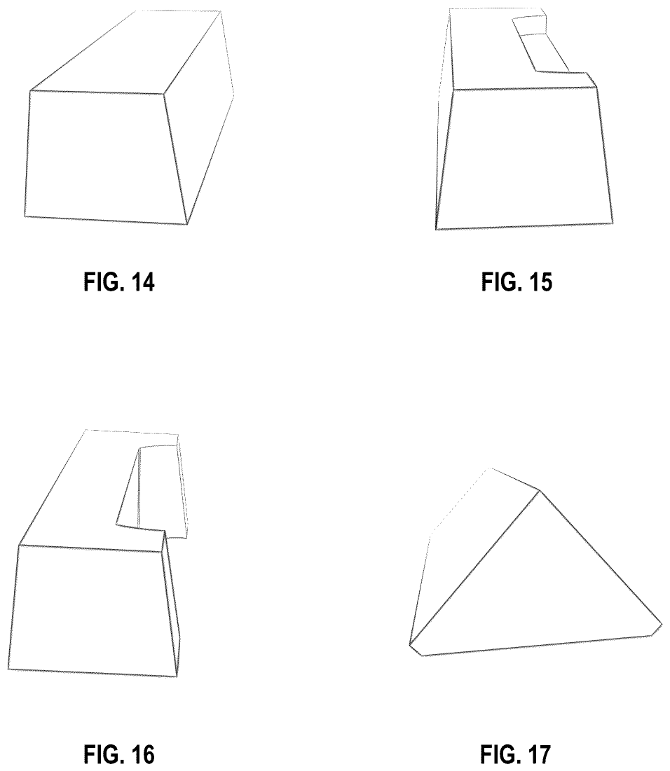

A ridge was constructed from 1.6 PCF EPLA and incorporating a trapezoidal profile with a 1″ top width, 1 ⅜″ base width, a length of 4″, and a height of 1 ⅝″. FIG. 14 depicts an example of the ridge that was formed. Three trapezoidal ridges were tested under compression to 10% and 20% of their initial height. At 10% compression, the ridges exhibited an average compressive strength of 19.35 psi, while at 20% compression, the average compressive strength was 26.35 psi. The compression set, recorded as per ASTM D3575, indicated that the ridges recovered to 99% of their original height at 10% compression and 96% of their original height at 20% compression, demonstrating high resilience in shape recovery.

An additional trapezoidal ridge with identical dimensions was subjected to a “pre-stressing” process, wherein it was initially compressed to 20% of its height and allowed a 24-hour recovery period before retesting. This pre-stressed ridge displayed a compressive strength of 10.5 psi at 10% compression and 14.5 psi at 20% compression, with a 99.5% recovery rate, indicating almost complete recovery.

A final trapezoidal ridge was compressed to 60% of its original height to assess structural integrity. No observable cracks, fractures, or surface splits were noted under this higher compressive load, confirming the ridge's durability across varying compression levels.

### Example 8: Trapezoidal Ridge with a Narrow “Cut-Out”

A ridge sample was constructed from the same 1.6 PCF expanded polylactic acid EPLA material as Example 7, designed similarly to the trapezoidal ridge in Example 7 but incorporating a ½-inch narrow cut-out, removing 30% of the ridge's surface contact area along its first ½ inch. FIG. 15 depicts an example of the ridge that was formed. Three trapezoidal ridges with this cut-out feature were tested under compression to 10% and 20% of their initial height. At 10% compression, the ridges exhibited an average compressive strength of 14.7 psi, and at 20% compression, the average compressive strength was 22.4 psi. Compression set, recorded per ASTM D3575, indicated that the ridges recovered to 99% of their original height at 10% compression and 97% at 20% compression, demonstrating high resilience in shape recovery. Compared to the trapezoidal samples in Example 7, these cut-out ridges experienced a 15-25% reduction in compressive strength, along with a 6% reduction in overall weight and a 30% reduction in surface contact area along the initial ½ inch.

### Example 9: Trapezoidal Ridge with a Full-Depth Cut-Out

A second ridge sample was constructed from the same 1.6 PCT EPLA material as Examples 7 and 8, also similar in design to the trapezoidal ridge in Example 7, but with a full-depth cut-out feature that removed 30% of the ridge's surface contact area, creating an elongated C-shape. FIG. 16 depicts an example of the ridge that was formed. Three trapezoidal ridges with this full-depth cut-out feature were tested under compression to 10% and 20% of their initial height. At 10% compression, these ridges demonstrated an average compressive strength of 13.2 psi, and at 20% compression, an average compressive strength of 20.1 psi. Compression set measurements indicated that the ridges recovered to 99% of their original height at 10% compression and 97% at 20% compression, showing high resilience in shape recovery. Compared to the standard trapezoidal ridge, these full-depth cut-out samples exhibited a 24-32% reduction in compressive strength, along with a 30% reduction in both weight and surface contact area.

### Example 10: Triangular Ridge Test

An additional ridge sample was constructed from the same 1.6 PCT EPLA material as Examples 7-9, designed as an isosceles triangle with the broader dimension as the base and the apex as the ridge. This triangular ridge measured 4″ in length, 1 ⅜″ in height, and 2 ¼″ in base width. FIG. 17 depicts an example of the ridge that was formed. The apex of the ridge consisted of a single bead in length. Upon testing, the triangular ridges exhibited an average compressive resistance of 42 pounds-force after 10% deflection and 55 pounds-force after 20% deflection. Due to the variable surface area in contact as compression progressed, pounds per square inch (psi) were not computed, and only total compressive resistance in pound-force was recorded.

An additional triangular ridge with identical dimensions was subjected to a “pre-stressing” process, wherein it was initially compressed to 20% of its height and allowed a 24-hour recovery period before retesting. This pre-stressed ridge displayed a compressive strength of 6.5 psi at 10% compression and 7.5 psi at 20% compression, with a 99.5% recovery rate, further indicating almost complete recovery.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirit and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure is not to be seen as limited by the foregoing but is only limited by the scope of the appended claims.

We claim:

1. A molded foam article formed from polylactic acid comprising at least one ridge.

2. The molded foam article of claim 1, wherein the molded foam article is a bead-foam article composed of a plurality of expandable beads.

3. The molded foam article of claim 1, wherein the molded foam article has a density that has been increased post-molding through at least one compression cycle.

4. The molded foam article of claim 1, wherein the molded foam article and the ridge are monolithic and formed simultaneously by a molding process.

5. The molded foam article of claim 1, wherein the at least one ridge is adhered to a surface of the molded foam article.

6. The molded foam article of claim 1, wherein the ridge comprises at least one protrusion.

7. The molded foam article of claim 6, wherein the at least one protrusion extends along a length of the molded foam article.

8. The molded foam article of claim 6, wherein the at least one protrusion comprises a triangular pyramid, a triangular prism, a rectangular prism, and/or a honeycomb-shaped protrusion.

9. The molded foam article of claim 1, wherein the ridge comprises at least one channel.

10. The molded foam article of claim 9, wherein the at least one channel extends along a length of the molded foam article.

11. The molded foam article of claim 9, wherein the at least one channel comprises a triangular pyramid, a triangular prism, a rectangular prism, and/or a honeycomb-shaped channel.

12. The molded foam article of claim 1, further comprising one or more inorganic additives.

13. The molded foam article of claim 12, wherein the inorganic additive is graphite.

14. A package for shipping a product, the package comprising the molded foam article of claim 1.

15. A method for forming a molded foam article, the method comprising:
molding a plurality of foam beads comprising polylactic acid, wherein the molding process comprises:
injecting the plurality of foam beads into a mold, and
subjecting the mold to an elevated temperature and reduced pressure to expand the foam beads,
wherein the molded foam article has at least one ridge; and
subjecting the molded foam article to at least one compression cycle.

16. The method of claim 15, wherein the at least one ridge is formed as part of the molding step.

17. The method of claim 15, wherein the at least one ridge is formed through subtractive machining.

18. The method of claim 15, further comprising:
forming at least one ridge, and
adhering the at least one ridge to the molded foam article.
